(19) United States
(12) Patent Application Publication
(10) Pub. No.: US 2010/0098863 A1
(43) Pub. Date: Apr. 22, 2010

(54) Process for spontaneous deposition from an organic solution

(75) Inventors: Thomas J. O'Keefe, Rolla, MO (US); Matthew J. O'Keefe, Rolla, MO (US)

Correspondence Address: PEACOCK MYERS, P.C., 201 THIRD STREET, N.W., SUITE 1340, ALBUQUERQUE, NM, 87102, US

(73) Assignee: University of Missouri, Columbia, MO (US)

(21) Appl. No.: 10/799,905

(22) Filed: Mar. 12, 2004

Related U.S. Application Data
(60) Provisional application No. 60/454,529, filed on Mar. 12, 2003.

(51) Int. Cl. B05D 3/10; B05D 1/18; B05D 3/12

(52) U.S. Cl. 427/307; 427/430.1; 427/331

(57) ABSTRACT

Deposition coating from an organic solution. The present invention utilizes an organic solution to plate a deposition material onto a substrate. The substrate is seeded to facilitate subsequent deposition. A superior deposition coating is provided.

### CROSS-REFERENCE TO RELATED APPLICATIONS

This application claims the benefit of the filing of U.S. Provisional Patent Application Ser. No. 60/454,529, entitled “Deposition From An Organic Solution”, filed on Mar. 12, 2003, and the specification thereof is incorporated herein by reference.

### GOVERNMENT RIGHTS

The U.S. Government has a paid-up license in this invention and the right in limited circumstances to require the patent owner to license others on reasonable terms as provided for by the terms of SBIR Contract No. F33615-97-C-1074 awarded by the U.S. Air Force Research Laboratory.

### BACKGROUND OF THE INVENTION

1. Field of the Invention (Technical Field)

The present invention relates to a process for spontaneous metal deposition from organic solutions onto solid substrates.

2. Description of Related Art

Note that the following discussion refers to a number of publications by author(s) and year of publication, and that due to recent publication dates certain publications are not to be considered as prior art vis-a-vis the present invention. Discussion of such publications herein is given for more complete background and is not to be construed as an admission that such publications are prior art for patentability determination purposes.

Copper and gold are currently being used for interconnection technology and microelectromechanical systems (MEMS) structures for manufacture of advanced silicon integrated and printed circuits because of low bulk electrical resistivity and resistance to electromigration. These materials have been utilized in circuits after deposition by physical vapor deposition (PVD), metal organic chemical vapor deposition (MOCVD), electroless plating, and electroplating. The latter two are particularly attractive as deposition methods because they provide high step coverage, good adhesion, high selectivity, ease of processing, and are economical.

With respect to gold, a plating process can be used to deposit gold on selective areas of an electronic package. The gold immersion process is unique in that it is spontaneous and requires no external power source, thus allowing deposition in electrically isolated areas, prevalent in many microcircuit applications. Most of the prior art immersion solutions contain potentially toxic cyanide, which necessitates an alkaline pH be maintained for safety reasons. The efficiency and stability of the reducing agent used in prior art applications is also improved at higher pH. However, such high pH solutions are corrosive to polymeric components and resist layers. Therefore, it would be beneficial to utilize a process (and solution) which does not require such high pH for effective use and is environmentally acceptable.

It is known in the art that aqueous solutions that contain one or more dissolved metals in ionic form may be subjected to solvent extraction for the recovery of one or more desired metals. The desired metal ions are usually extracted from an aqueous solution, into an organic solvent containing an extractant, and are recovered from the loaded solvent by stripping with a suitable aqueous strip solution. Other metals that may be present as ions in the aqueous solution as impurities, must often be removed from the process as they may cause difficulties in the stripping of the desired metal, and often increase in concentration in the circulating solvent to an extent that affects the efficiency and purity of the extracted solution.

Methods that are used alone and in combination for removing desired and impurity cations present in solvent extraction processes for aqueous solutions include the conventional stripping or selective stripping with acidic, basic or controlled anion or cation containing solutions and the more recently developed hydrogen reductive stripping, hydrolytic stripping and electrolytic stripping.

Stripping is often accomplished with the chemical solutions under ambient or elevated temperature conditions. Hydrogen reductive stripping is carried out at temperatures between 150° C. and 350° C. under elevated pressure and usually in the presence of seed metal particles to produce a metal powder. In hydrolytic stripping, loaded solvent is subjected to elevated temperatures (100° C.-250° C.) in the presence of water whereby metal oxides or hydroxides are formed. A thorough review of hydrogen reductive stripping and hydrolytic stripping may be found in Monhemius, A. J., Mintek 50, pp. 599-609. Electrolytic stripping has been applied to a loaded solvent by subjecting the solvent to electrolysis with electrodes placed in the loaded solvent (Wan, R. Y., et al. J. of Metals, December 1986, pp. 35-40).

Ferric ion may also be stripped from various loaded organic solvents into the aqueous phase with an acid alone or combined with the introduction of sulfur dioxide or hydrogen sulfide to reduce ferric to ferrous. The stripping may be carried out at ambient or elevated temperatures and pressures. It is noted that iron is often present in solvent extraction processes as ferric and that, in many cases, ferrous is the stable form in the aqueous phase in non-oxidizing conditions.

The above prior art methods have a number of disadvantages. In conventional stripping, high concentrations of the chemical species comprising the strip solution are often required. Where lower concentrations are used, the processes are complicated by, for example, use of combinations of extractants. Hydrogen precipitation and gaseous and/or hydrolytic stripping, especially under elevated pressure and at higher temperatures, are expensive and complex.

In aqueous hydrometallurgical processes use is often made of galvanic reactions between metals that cause reduction of a metal cation and precipitation, i.e. cementation, onto an added solid metal. This had not been applied to solvent extraction processes until 1991 as described in U.S. Pat. No. 5,228,903 to O'Keefe. Any methods disclosed for the reduction of metal cations to reduce and cement metal cations onto an added solid metal had previously been applied before carrying out the solvent extraction. According to Canadian Patent No. 1,250,210, a solution containing iron and zinc was treated in two stages with metallic iron and zinc to reduce ferric to ferrous iron and cementation of copper, arsenic, antimony and bismuth on the iron, followed by precipitation of a sludge of tin, cadmium and lead in the second stage treatment with zinc dust. After this two-stage pre-treatment in an aqueous system, zinc chloride was extracted with an organic liquid. The reduction stages were, therefore, essentially separate from the solvent extraction process. It is noted that no metal was actually deposited onto the zinc powder in the second stage.

Shibata et al. reported that ferric iron can be stripped from di-2-ethyl-hexylphosphoric acid (D2EHPA) with mineral acid and iron powder (Proc. Symp. Solvent Extr. 1986, 139-142). Shibata et al. only disclosed the stripping of ferric iron from D2EHPA with iron powder. Shibata et al. did not disclose the galvanic stripping with metals other than iron, or the deposition of metals onto added metals, or stripping of metals other than iron from organics other than D2EHPA.

Taking the above-mentioned teachings of the Canadian Patent and Shibata et al., one could not presume a priori that the Shibata et al. method was operable with zinc powder or metals other than iron and zinc. Similarly, it could not be presumed that the Shibata et al. method was operable with organics other than D2EHPA, or that actual deposition of a metal species dissolved in an organic liquid would occur in the organic phase onto an added solid metal. It could also not be presumed that addition of a solid metal to an organic phase would make it possible to reduce metal ions other than ferric ions in the organic phase from a higher to a lower state of oxidation.

One article, “Novel Electrochemical Processing Using Conventional Organic Solvents” by O'Keefe, et. al. Proceedings of the International Solvent Extraction Conference, ISEC Mar. 18-21, 2002, discusses the history of electrochemical processing using conventional organic solvents, including the processes of galvanic stripping, simultaneous and separate galvanic stripping, an electrochemical model and metal deposition for microelectronic applications. This reference, not prior art as to the present invention, is related to the present invention in that it relates to the in situ organic process of the present invention, and is hereby incorporated by reference.

Other articles by one or more of the inventors (and others) provide an introduction or background of the use of electrochemical processes using organic solvents. These include: Final Report for 17 Sep. 1998-15 Jul. 2000, to Air Force Research Laboratory, entitled “Unique Selected Area Deposition of Copper Onto Aluminum for Multi-Chip Module Applications” (unpublished); “Organically Deposited Metallic Films for Device Fabrication”, Materials Research Society Symposium Proceedings, Volume 514, Advanced Interconnects and Contact Materials and Processes for Future Integrated Circuits, pp. 473-477, Apr. 13-16, 1998; “Maskless, Direct Deposition of Copper onto Aluminum Bond Pads for Flip Chip Applications”, Materials Research Society Symposium Proceedings, Volume 515, Electronic Packaging and Materials Science X, pp. 85-90, Apr. 13-16, 1998; “Development of a Unique Deposition Process for Thin Film Calibration Sensors”, Surface and Coatings Technology No. 113, 1999, pp. 210-217; “Characterization of Organic Solution Deposited Copper Seed Layers on Al(Cu) Sputtered Thin Films”, Journal of Vacuum Science Technology, Vol. B 17(5), September/October 1999, pp. 2366-2372; “Organic Solution Deposited Copper Seed Layers onto Barrier Metals”, Materials Research Society Symposium Proceedings, Volume 612, “Materials, Technology and Reliability for Advanced Interconnects and Low-K Dielectrics,” pp. D.19, Apr. 23-27, 2000; “An Alternative Metallic Seeding Technique for Subsequent Electrochemical Deposition of Copper onto Barrier Metals”, Conference Proceedings ULSI, XVI 2001, Materials Research Society, pp. 137-143, first published in Advanced Metallization Conference 2000 (AMC 2000) Conference Proceedings Oct. 2-5, 2000, University of California; “Spontaneous, Non-Aqueous Electrochemical Deposition of Copper and Palladium on Al and Al(Cu) Thin Films”, Journal of Electronic Materials, Vol. 30, No. 4, 2001, pp. 349-354; “Spontaneous Electrochemical Processing in Conventional Organic Solutions for Fe³⁺Removal and Metal Deposition”, Dissertation in Metallurgical Engineering, University of Missouri-Rolla, 2002, pp. 1-210 (publication date unknown); “Gold Deposition from Organic Media Using Galvanic Displacement Plating”, UMR Materials Research, Dept. Metallurgical Engineering, University of Missouri-Rolla, (publication date unknown); “Electrochemical Palladium and Copper Deposition onto Barrier Materials from Organic Solutions”, University of Missouri-Rolla, (publication date unknown), pp. 123-161; and “Pd—Cu Co-Deposition on TiSiN as Seeds for Electroless Plating”; (unpublished). None of the articles discuss the particular deposition coating process of the present invention. All of these articles and publications are incorporated herein by reference.

The present invention, in contrast, deposits a coating on a substrate using an organic solution as the plating bath. The invention uses galvanic coating and a displacement reaction.

Use of the process of the present invention allows a good quality, adherent and uniform displacement nucleation film to be deposited directly on the substrate using an organic rather than an aqueous solution. This coating or deposit can serve as a stand alone film or as the basis or foundation for additional, thicker films to be deposited using conventional, inexpensive methods.

### SUMMARY OF THE INVENTION

### Disclosure of the Invention

The present invention comprises a method of forming a deposited coating layer on a substrate. The method comprises the steps of providing an organic solution with a desired deposition component, providing a deposition substrate, which may include a barrier layer, forming on the less noble deposition substrate a seed composition comprising a more noble deposition component or components, depositing the desired component from the organic solution onto the substrate, by reducing a cation of the desired deposition component to form on the substrate or seed composition.

The seed composition source may comprise a metal, compound or ion. The deposition component or substrate may comprise a metal, metal alloy, and/or a barrier layer metal, such as, but not limited to a metal nitride. Useful substrate or barrier layer materials compositions include, but are not limited to, tungsten-based, tantalum-based, and titanium-based compositions, such as Ti, Ta, W, TiN, TaN, W₂N, TiSiN, WN, WSiN, and TaSiN, and other compositions or metals, e.g., Cu, Ni, Fe, Al, steel, Zn and Ag. Useful seed compositions include, but are not limited to, copper, platinum, palladium, gold, silver, zinc, cadmium, lead, cobalt, nickel, and mixtures thereof. Useful deposition components include but are not limited to copper, platinum, palladium, gold, silver, zinc, cadmium, lead, cobalt, nickel and mixtures thereof. The organic solutions may comprise one or more deposition components. The desired deposition component may be loaded into the organic solution from an aqueous solution or a suitable solid metal or compound.

The method may further comprise the step of treating the deposition substrate. This may include introducing a halogenated compound into the organic solution, such as HBF₄, HF, NaF, H₂SiF₆, and HCl, or any suitable halogenated or non-halogenated organic or inorganic acids or bases, such as H₂SO₄.

The substrate may be etched, either by pre-etching prior to the deposition step or in-situ etching during the deposition step.

The organic solution may be a single phase solution or a two-phase solution. Preferred compositions to include in the organic solution are D2EHPA, TBP, kerosene or suitable organic diluents to maximize reactivity and seed properties, but the invention is not limited to these compounds.

The organic solution may be mixed or agitated, e.g., by ultrasonic agitation to enhance the seed layer characteristics. The organic solution may further comprise at least one additive including alcohols, carboxylic acids, aldehydes, ketones, esters, phenols, amino acids and other organic groups to enhance the process.

The organic solution is preferably an extractant, such as, but not limited to, a solvating extractant, chelating extractant, anion exchange extractant and/or a cation exchange extractant or mixtures thereof.

The additive may be an organic additive to enhance deposit characteristics, such as, but not limited to, alcohols, alkyl halides, ethers, carboxylic and dicarboxlic acids, aldehydes, ketones, amines, carbanions, phenols, amino acids, ascorbic acid, proteins, carbohydrates and/or sulfonated organics.

The additive may be an inorganic additive, such as, but not limited to, water, acids, bases, activating cations and/or activating anions.

The deposition occurs using two galvanic half-cell reactions. Simultaneous or separate galvanic coating may be used.

The method may further comprise transporting reacting species. Likewise, the method may further comprise using temperatures from ambient to elevated levels (at safe levels).

A primary object of the present invention is to provide a process for deposition of a component from an organic solution onto a solid substrate.

A primary advantage of the present invention is that the process of the invention allows a good quality, uniform, adherent deposit to be spontaneously placed on the solid, conducting substrate.

Another advantage is that the reaction is electrochemical in nature and occurs directly in a suitable organic media which is typically not a good electrically conducting electrolyte.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIGS. 1a-1c illustrate the process of the present invention for deposition of more noble metals from an organic solution onto a less noble metal substrate, over time; and

FIGS. 2a-2c illustrate the process of the present invention for deposition of gold from an organic solution onto a less noble metal substrate, nickel, over time.

FIG. 3 illustrate the processes of the present invention for simultaneous coating and separate coating.

### DESCRIPTION OF THE PREFERRED EMBODIMENTS

### Best Modes for Carrying Out the Invention

The present invention comprises a process for deposition or co-deposition or reduction of components, such as metals or ions, on a desired substrate utilizing electrochemical displacement or displacement coating mechanisms wherein a metal ion is completely or partially reduced on a substrate for continued or subsequent metal deposition. Preferably, a uniform, reproducible metal (e.g., Cu) surface is produced on the desired substrate layer (e.g., a silicon or other substrate). In the process, two galvanic half-cell reactions, including seed deposition and removal of the substrate, may occur substantially simultaneously to achieve such deposition. The galvanic reaction mechanisms are conducted in an organic media rather than in conventional aqueous solutions.

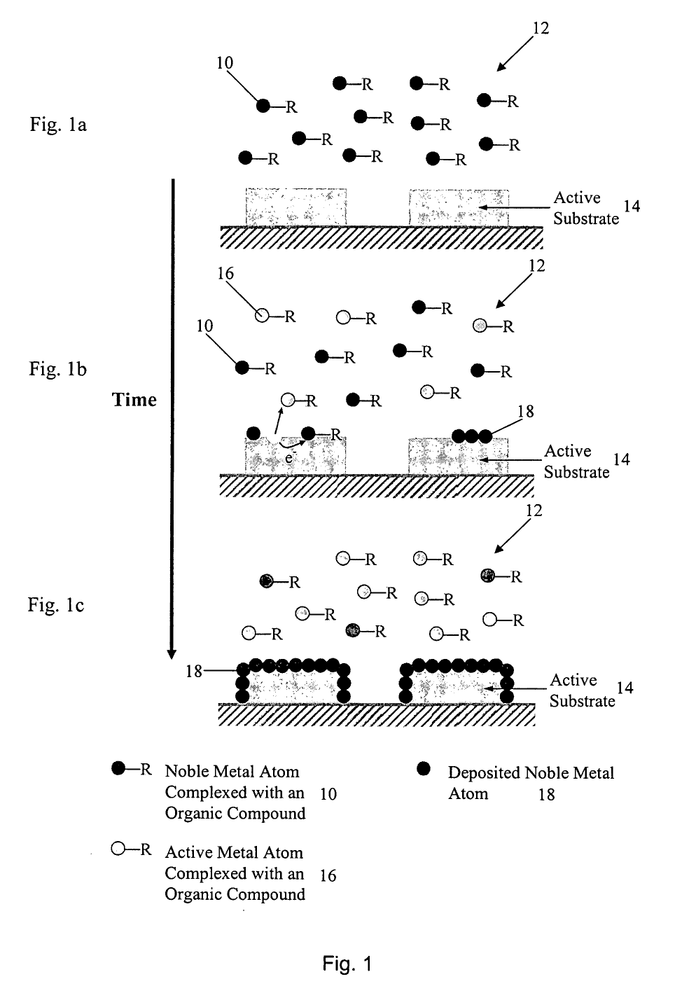

As shown in the drawings, FIGS. 1a-1c illustrate the mechanism for deposition of noble metals from an organic solution onto a more active, or less noble, metal surface substrate, over time. FIG. 1a shows noble metal atoms complexed with an organic compound 10 in solution 12, in the initial stage. An example would be a gold atom complexed with an organic compound. At a later time, as illustrated in FIG. 1b, the noble metal atoms complexed with an organic compound 10 are reduced at cathodic sites on the active substrate 14 to the metallic state 18 (e.g. gold atoms). Simultaneously, the active metal atoms are oxidized into the organic solution and form a soluble complex 16. At this stage (FIG. 1b), both noble metal atoms 10 and active metal atoms 12 complexed with an organic compound are present in solution. Noble metal atoms 18 (e.g. gold atoms) begin to deposit on active substrate 14. At a later stage (FIG. 1c), deposited noble metal atoms 18 cover active substrate 14, preferably forming a noble metal film layer (e.g. a gold film layer).

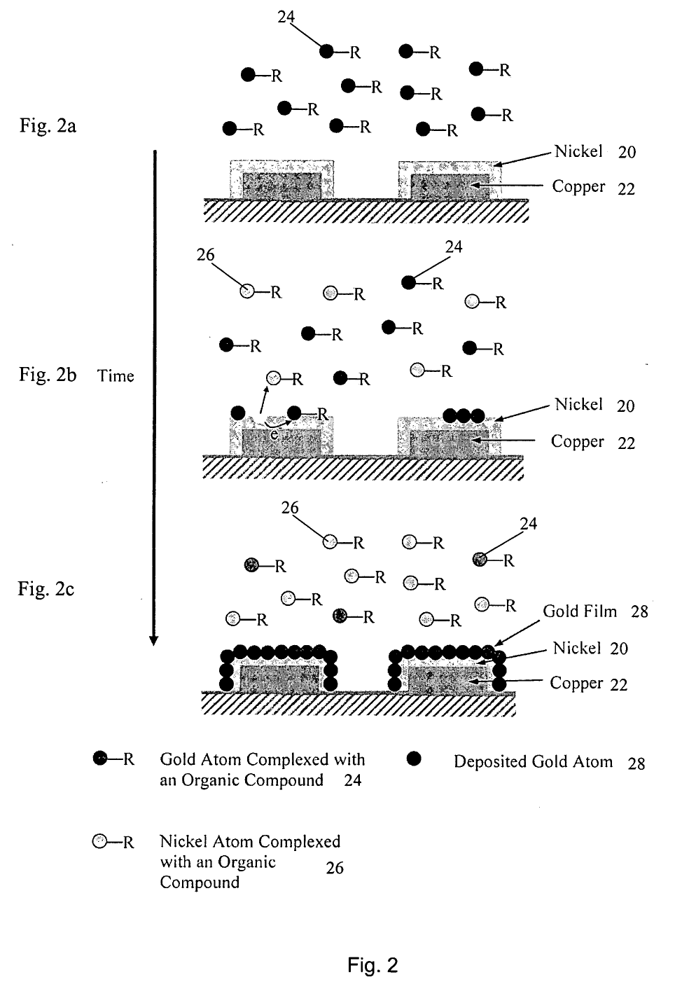

FIGS. 2a-2c illustrate, over time, an example using an active nickel substrate 20 over a copper substrate 22 in which a noble metal atom (e.g. gold) complexed with an organic compound 24, is reduced at cathodic sites on the active nickel substrate 20. The nickel dissolves into the organic as a complex by means of an oxidation reaction. The gold atoms 28 continue to deposit and form a film on, or replace, the nickel. Deposited gold atoms 28 form a film on or replace nickel seed layer 20. The use of gold and nickel in this example are used for illustration purposes only to show how a more noble metal (gold) is deposited on the less noble seed layer or substrate (nickel). As can be appreciated by those skilled in the art, this example and the example set forth in FIGS. 1a-1c, are applicable for any more noble/less noble metals, ions, alloys, compositions, materials, and the like.

The loading of an organic solution is accomplished by dissolving a desired metal, a salt or extracting an ion for deposition, providing its ion in solution. Therefore, the metal to be dissolved must be one that is known in the art to be soluble in a particular organic for appropriate selection of an organic solution. Given the general physical laws known for the behavior of metals in aqueous solution, a “more” noble metal dissolved in an organic solution could preferentially deposit on a “less” noble surface or substrate species. For example, Au, Pt, Pd, Cu, and Ag would all readily plate on substrates such as Al, Cd, Ti, Ta, Zn, Fe, and Si, or mixtures thereof. Other possible deposition metals include Pb, Zn, and Sn or mixtures thereof. However, the invention is not limited to these metals. Further, this process is not limited, but is easily extendable to other ions, not just metallic ions, given individual ordering theory (e.g., Zn ions would plate on Al). The chemical and electrochemical reactions can involve the removal of a surface coating, (e.g., oxides, nitrides, etc.) of a barrier layer followed by the deposition of a suitable seed layer to activate the element of the barrier layer for subsequent metal/element deposition.

The substrate or barrier layer is activated for further metal build up by the seed layer. The seed particles are preferably very small (e.g. nanometer size), but can be of any size, depending on the metal/ion, solution, substrate, etc. For electroless deposition processes the seed layer acts as catalytic surface allowing the metal/ion to reduce on those sites. The reducing agent and the metal/ion are in solution, but they react only on the activating species surface. (Even though the organic solution is a poor electrical conductor). This reaction is effective as a localized electrochemical cell. Dissolving occurs in one location and deposition or reduction takes place near it; this addresses around the conductivity problem in a “poorly conducting” organic solution. Different size and density of nuclei are achieved with the present invention.

Reduction of the metal ion in the organic solution to a seed particle on the substrate occurs over a very localized range (microscopic level) because of the poor electrical conductivity of the solution. Here, one does not have to carry a current a long distance. Accordingly, the cathode will be very close to the anode (e.g. nanometers or micrometers in distance). This provides an advantage over prior art aqueous solutions in that a good coating can be highly localized on selected sites. Organic solutions are very polarizing and therefore may provide for better, finer grained coatings. In addition, the organic solution provides better protection of the substrate from oxidation, than might be expected with aqueous solutions.

The organic solution of the present invention has low conductivity (e.g. 10⁻⁸ to 10⁻⁶ S/Cm as opposed to 10⁻¹ for a prior art aqueous solution). The organic solution is very highly polarizing, and has very high resistivity.

Under proper process conditions some of the deposits completely cover the surface (e.g. Au on Ni). The seed layer is deposited and the deposition component continues to plate and build up, growing from the original seed site. Because the displacement reaction is electrochemical, there is better adherence. The process is useful for patterned or unpatterned substrates. The substrate acts as the anode in the displacement electrochemical reaction.

Although the term “organic solution” is used throughout the specification and claims, this definition is intended to include a substantially organic solution that may or may not include a small amount of water (e.g. less than 5% by volume, preferably less than 1% by volume and most preferably less than 0.25% by volume).

The organic solution may be a single or two-phase solution. When the water is dissolved it is a clear single phase organic solution. When the water is not completely dissolved, it results in the formation of a second phase. Depending on the desired characteristics of the deposited film, either single or multiple phase solutions can be used.

The following components of the organic solution are useful in the present invention. More than one of any of the these components may be combined in the organic solution.

a. Extractant: the reactant organic or compound containing the functional group that is capable of chemically reacting with and holding the desired deposition component in the organic deposition solution.

b. Diluent, or carrier: inert compounds such as kerosene (aliphatic), rykue (aromatic), napthene (napthenic) or other commercially available compounds (e.g. ORFOM series by Phillips 66 Mining Chemicals).

c. Additives (optional): other organic or inorganic acids, bases or salts incorporated into the organic to enhance the deposition reaction or phase formed.

There are four categories of extractants useful in the method of the present invention. These include:

1. Solvating extractants;

2. Cation exchange reactants;

3. Chelating extractants; and

4. Anion exchange extractants.

Examples are as follows:

A useful organic solution in accordance with the present invention comprises Di-(2-ethylhexyl) phosphoric acid (D2EHPA) and tri-n-butyl phosphate (TBP). Kerosene is useful as a diluent for the organic phase.

Mixing (e.g. vigorous shaking and/or ultrasonic agitation) is useful for loading the desired ion from a suitable source into the organic phase. Additives affect, influence and enhance the reaction sequence, facilitate reaction kinetics and water distribution and concentration in the organic solution, which improves the properties and performance of the metal films. Activating agents are particularly useful in accordance with the present invention. Useful additive categories are alcohols, carboxylic acids, aldehydes, ketones, esters, phenols and amino acids.

A generic cementation reaction in an organic solution (FIGS. 1 and 2) involves using a less noble metal (or other less noble element, including non-metals) (designated as M₂) to serve as a reducing agent for a more noble cation (M₁⁺).

LM₁⁺+M₂⁰=LM₂⁺+M₁⁰

The equilibrium potentials for LM₁⁺/M₁ and LM₂⁺/M₂ reflect the relative driving force for oxidation and reduction and each can be written as a separate, half-cell reaction, a condition which is unique to electrochemical reactions. While the thermodynamics of the cementation reactions can be used to theoretically predict reaction tendencies, in actual practice the reactions are often strongly influenced by the system kinetics. As a result, the degree and types of polarization inherent to the systems often dictate the extent and efficiency of the reactions. One outcome of this behavior is that a wide range of chemical and operating modifications may be employed to control the cementation reactions and provide a broader range of separation options.

In principle, the galvanic coating process of the present invention is a cementation reaction. The major difference is the nature of the liquid media in which the reactions occur. Instead of the aqueous solution of the prior art, an organic solution is utilized in the present invention. All ionic or neutral components must be soluble in the chosen organic. As the organic solution of the present invention is not a good electrolytic conductor (as are the prior art aqueous solutions), the deposition occurs in a different manner than conventional electrolytic reactions. This condition imparts a high degree of polarization to the system and forces the spontaneous reactions to occur over a relatively short range because of the high solution resistivities. This is in contrast to the aqueous solutions of the prior art in utilizing electrodes where the reactions can occur over much longer ranges because of the lower solution resistivities.

In this method of coating, the chelation or primary solution structure is an organic entity, probably similar to that encountered in standard solvent extraction. Examples of reactions involving either complete or partial reduction of an M₁ cation by the less noble M₂ species (non-metals may be substituted in place of the metals so long as they are soluble in the organic and of the appropriate more/less noble configuration) using a suitable organic ligand L are:

2L₃-Fe³⁺+Zn⁰→2L₂-Fe²⁺+L₂-Zn²⁺

3L₂-Cu²⁺+2Al⁰→3Cu⁰+2L₃-Al³⁺

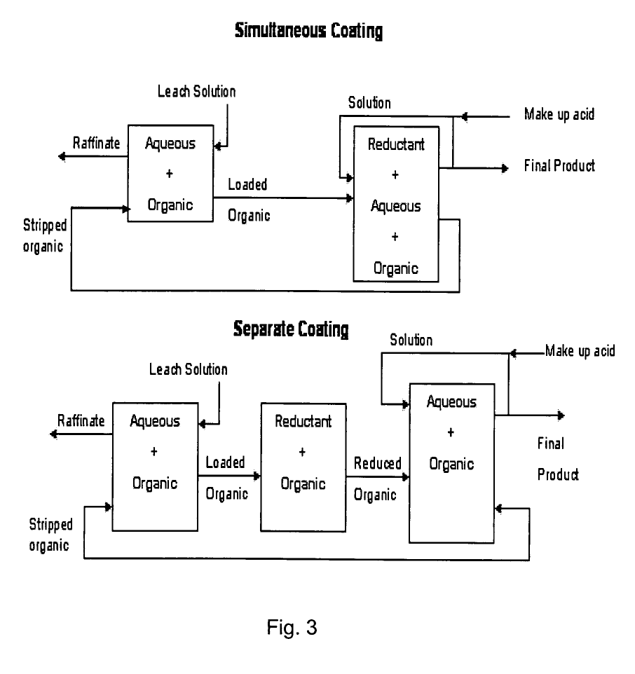

Two process variations can be used to carry out the galvanic reactions and are referred to as simultaneous or separate coating as illustrated in FIG. 3. In simultaneous galvanic coating, the loaded organic, the solid metal reductant and an aqueous stripping phase are allowed to react before settling and separating. This arrangement seems more efficient for partial reduction separations, for example, reducing Fe³⁺ to Fe²⁺ or Ce⁴⁺ to Ce³⁺ that then easily transfer into the aqueous stripping phase. In separate galvanic coating the reduction reaction takes place in the organic solution that had been loaded with the deposition component in a prior step. For low concentration cation impurity removal, metal deposition or seed crystal nucleation for microelectronic applications, the separate galvanic coating process has been more effective. An example of the latter is the cementation of Cu on Al, Pd on AI, or Au on Cu.

Since copper and aluminum are soluble in silicon and low-k dielectric materials, a reliable barrier layer must be in place before deposition of the copper metallization. Several barrier materials, including but not limited to Ti, Ta, W, TiN, TaN, W₂N, TiSiN, and TaSiN, or mixtures thereof, are useful barrier materials for both aluminum and copper interconnects. Titanium nitride is useful for Cu/SiO₂/Si diffusion barrier applications; however, its use in a polycrystalline columnar microstructure is not preferred. Ultrathin polycrystalline TiN or TaN layers may allow a fast diffusion path for Cu along the grain boundaries. Therefore, it is desirable to use an amorphous diffusion barrier material. Ternary amorphous metallic thin films made of combinations of a transition metal and nonmetals (e.g., Si, N or B) are also useful. Other useful types of thin film materials include but are not limited to TaSiN, TiSiN, WBN and WSiN.

Copper can be deposited on diffusion barriers by several methods, including physical vapor deposition (PVD), chemical vapor deposition (CVD), and electrochemical deposition (ECD). Of these techniques, electrochemical deposition is particularly attractive for economic and process integration reasons. Electrochemical deposition of Cu onto diffusion barrier films requires a seed layer of Cu (or other suitable metal, e.g., Pd) to be deposited by PVD (e.g., sputtering) or CVD.

In preferred embodiments of the invention, the electrochemical mechanisms may be better utilized when pre-treatment/pre-etching and in situ etching is used.

### Pre-Treatment/Pre-Etching Step

Pre-treatment/pre-etching of the substrate, as opposed to in situ etching, utilizes a separate step for an etching/cleaning of the substrate prior to coating or seeding in the organic solution. In a preferred embodiment, a barrier layer is pre-treated and then seeded using a loaded organic solution. Typically, barrier layers comprise a tungsten-based, tantalum-based, or titanium-based composition, including but not limited to Ti, Ta, W, TiN, TaN, W₂N, TiSiN, WBN, WSiN, TaSiN and mixtures thereof. Seed layers comprise a preferably small, nano-sized particle deposited on the less noble barrier or other substrate layer and typically comprise a metallic element, such as, but not limited to, palladium-based compositions, elemental palladium, copper-based compositions, elemental copper, gold-based compositions, elemental gold, elemental silver or mixtures thereof.

A particularly useful pre-treatment method utilizes a HBF₄ solution to both potentially clean and/or remove inhibitive species, such as oxides. It is preferred that HBF₄ (or other halogenated pre-treatment solutions), such as but not limited to fluorosilic acid, HF, sodium fluoride or any other halogen solutions be used.

Once the HBF₄, or other pre-treatment solution, cleans and/or removes any inhibiting species present on the surface layer, the substrate surface is then seeded using a solution comprising an organic with a desired metal (or other element) appropriately soluble in the organic. Each organic solution has a different solubility for particular ions. In accordance with the invention, one must find an organic solution which is chemically (must be able to dissolve the species) and electrochemically (allows electron transfer) capable of supporting the desired reactions.

### In Situ Etching Step

The pretreatment step may be complimented or obviated by utilizing a compound (e.g., a halogenated compound) as a part of the organic media (used in the deposition step), thereby allowing for simultaneous removal of the oxide or other surface layer and deposition of seed particles.

As shown in the following examples, either embodiment of the process of the present invention proves to be very effective in providing an adherent seed layer or coating that can be used in the as-deposited condition or as a starting surface for subsequent deposition processes.

### INDUSTRIAL APPLICABILITY

The invention is further illustrated by the following non-limiting examples.

### Example A

### Palladium Deposition on TiSiN

An experiment was carried out to deposit palladium (Pd) from an organic solution on a patterned silicon (Si) wafer coated with a barrier layer of TiSiN. The TiSiN layer thickness was approximately 15 nm. The substrates were rinsed with acetone prior to initiating the deposition process.

The wafer was pre-etched with a 25% HBF₄ solution for approximately one minute at 30° C. using ultrasonic agitation. The concentrations, times, temperatures and mixing parameters can be altered to optimize the cleaning and activation of the surface. In situ etching is also possible, but must be carefully controlled.

The organic solution comprises a mixture of 50 volume percent (v %) Tri-butyl-phosphate (TBP), 5 v % Di-2-ethylhexyl phosphoric acid (D2EHPA), and 45 v % kerosene (K) containing 200 ppm (mg/L) palladium as Pd²⁺. Other diluents may be used to replace kerosene to modify the coating process. A 9.1 v % acetic acid additive with 0.2 v % water can be added to give a single phase organic, as desired.

Samples of patterned, 15 nm thick TiSiN films on silicon wafers were introduced into the organic solution for times ranging from 30 seconds to three minutes at 30° C. Ultrasonic agitation of the solution was used during processing. The samples were then removed from the organic solution and rinsed with acetone and then blown dry with air. Palladium was detected on the surface of the specimen by energy dispersive spectroscopy (EDS) analysis.

Once the Pd was present, the surface was active for deposition of a copper thin film using conventional, available technology such as electrolytic and electroless deposition.

### Example B

### Platinum Deposition on Copper

Platinum ion from an aqueous source was loaded into an organic solution of 40 v % TBP and 60 v % K to give concentrations of 50, 500, 1000, 2000 and 5000 ppm. A copper foil substrate was acetone cleaned before being immersed into the organic solution.

The deposits were made using the solutions with the stated platinum concentrations for times from two seconds to 120 minutes, but the best results were obtained in the range of one to three minutes. The temperature was in the range of 25° C. to 55° C. Deposits were made with and without ultrasonic agitation.

The deposits were characterized using scanning electron microscopy (SEM) and chemical identification was done by EDS. The deposits made at a concentration of 5000 ppm Pt had a bright, shiny appearance but adherence to the substrate was poor. At 2000 ppm Pt a smooth, compact, fine grained deposit was obtained after one minute at 25° C. The EDS analysis indicated approximately 15 wt % Pt. The typical particle size was about 25 nm.

Ultrasonic agitation of the solution did not have a significant effect on the particle size or the amount of Pt deposited. Increasing the temperature increased the rate of Pt deposition on the Cu. The largest increase in rate was between 25° C. and 30° C. where the measured amount of Pt increased from 6 wt % to 14 wt % after one minute of deposition time. The amount of Pt was approximately 16 wt % at 45° C. and 18 wt % at 55° C. The Pt particle size was typically tens of nanometers, and increased slightly with temperature, but the surface coverage was not as good with increasing temperature.

The choice of processing parameters depends on the final use and properties desired. However, good quality Pt films can be produced on Cu over a wide range of operating conditions.

### Example C

### Platinum Deposition on Copper from Modified Organic Solutions

It was found that the appearance and adherence of the platinum to the copper substrate could be improved by adding various organic and inorganic materials to the organic deposition solution as shown in Table 1. The basic composition of the organic deposition solution described in Example B was modified to include D2EHPA. The concentration of platinum in the organic solution was between 85 to 850 ppm, the temperature was 30° C., and the deposition times were from one to ten minutes.

The effects of the various additives on Pt deposit color and adherence to the copper are also given in Table 1.

TABLE 1
Results of Platinum Coating Deposition on Copper and Their Solution
Compositions (in milliliters/solution)

| | Pt(4)/ | | | | | | | | | | | | | | | | | | Plating | | |
|---|---|---|---|---|---|---|---|---|---|---|---|---|---|---|---|---|---|---|---|---|---|
| No | ppm | T | D | K | Ac | Er | M | Et | P | Eg | HAc | OA | GOA | FA | CA | F | HBF4 | HF | Time/min | Color | Adhesion |
| 1 | 150 | 9 | 2 | 89 | | | | | | 1 | 5 | | | | | | | | 1 | Yellow | |
| 2 | 150 | 9 | 2 | 89 | | | | | | 1 | 5 | | | | | | | | 10 | Gray | Good |
| 3 | 120 | 8 | 6 | 86 | 2 | | 5 | | | 1 | 5 | 0.8 | | | | | | | 2 | Bright | Excellent |
| 4 | 150 | 16 | 36 | 48 | | | 50 | | | | | | | | | | | | 10 | Bright | Poor |
| 5 | 150 | 11 | 22 | 67 | | | 5 | | | | | 0.6 | | 10 | | | | 0.2 | 1 | Bright | Good |
| 6 | 150 | 11 | 22 | 67 | | | 5 | | | | | 0.6 | | 10 | | | | 0.2 | 2 | Bright | Excellent |
| 7 | 850 | 14 | 14 | 72 | | | 10 | | | | 5 | | | | | | 0.02 | | 1 | Bright | Good |
| 8 | 850 | 14 | 14 | 72 | | | 10 | | 1 | 5 | | | | | | | | | 2 | Bright | Excellent |
| 9 | 100 | 12 | 10 | 78 | 5 | | 2 | | | | | | | 5 | | | | | 3 | Bright | Excellent |
| 10 | 850 | 14 | 33 | 53 | 5 | | 10 | | | | | | 0.3 | | | | | | 1 | Bright | Medium |
| 11 | 850 | 14 | 33 | 53 | 5 | | 10 | | | | | | 0.3 | | | | | 0.1 | 2 | Bright | Medium |
| 12 | 850 | 15 | 28 | 57 | 5 | | 10 | | | | 5 | | 0.5 | | | | | | 1 | Black | Powdery |
| 13 | 85 | 2 | 3 | 95 | 1 | | 1 | | | | | | 0.1 | | | | | | 1 | Yellow | |
| 14 | 85 | 2 | 3 | 95 | 1 | | 1 | | | | | | 0.1 | | | | | | 2 | Yellow | |
| 15 | 85 | 2 | 3 | 95 | 1 | | 1 | | | | | | 0.1 | | | | | | 5 | Bright | Good |

T: TBP;
D: D2EHPA;
K: Kerosene;
Ac: acetone;
M: Methanol;
Et: ethanol;
P: propanol;
Eg: ethane glycol;
Er: ether;
Hac: acetic acid;
OA: oxalic acid;
GOA: glyoxylic acid;
FA: formic acid;
CA: citric acid;
F: formaldehyde

In general, excellent Pt deposits were made at any concentration between 85 ppm and 850 ppm if the proper additives were used at the appropriate concentration levels. Lower percentages of TBP and D2EHPA could produce good coatings, but the rate of deposition was much lower. In some instances, when high additive concentrations were used with longer plating times, deposit adherence was adversely affected. Another possibility was to make a dark, finely divided Pt deposit by combining a high Pt concentration with additives that gave a high rate of deposition which disrupted film continuity and uniformity, leading to powder formation.

### Example D

### Gold Deposition on Nickel

An aqueous gold (III) chloride solution was prepared by dissolving 0.5 grams of gold (Au) powder in 20 mL of aqua regia and diluting to 100 mL with deionized water in a 100 mL volumetric flask. The aqueous solution was then contacted with TBP organic extractant in a separatory funnel for five minutes in order to load Au into the organic. The Au loaded TBP was passed through silicon treated filter paper to aid in the removal of residual water. Finally, the Au loaded TBP was mixed with SX-1 diluent resulting in a 500 ppm Au organic solution consisting of 10 v % TBP and 90 v % SX-1. This mixture was agitated for 15 minutes and the organic solution transferred from the flask and into test tubes in 10 mL aliquots. After adding 1 v % mineral acid, either concentrated HCl or H₂SO₄, the solution was agitated in a temperature controlled ultrasonic bath for two minutes to emulsify the acid in the organic solution. A 0.5 μm thick sputter deposited nickel film on a silicon wafer was used as the substrate. The nickel coated wafer was placed into the organic solution and agitated in an ultrasonic bath at 30° C. Reaction of the sputtered Ni substrate specimens for times that varied from 30 seconds to 30 minutes indicated that the amount of gold on the surface, as measured by EDS in an SEM, increased rapidly from 0 wt % Au after half a minute to 44 wt % after two minutes to 64 wt % after five minutes. For times greater than five minutes the amount of gold detected did not significantly increase. The deposited gold films were fine grained and shiny in appearance, and adherence of the Au to the Ni was good. In some cases 0.5 v % to 3 v % Alamine 336 amine based organic extractant was added to the loaded solution before reaction. It was determined that as the amount of Alamine increased the amount of gold deposited on the substrate decreased.

### Example E

### Copper Deposition on Aluminum

The deposition of copper particles and films from organic solutions onto aluminum substrates was conducted for several combinations of organic solution compositions, processing parameters, and substrate configurations. The organic solution most often used consisted of 20 v % TBP, 30 v % D2EHPA, and 50 v % kerosene in which 0.5 g/L Cu²⁺ had been loaded. The activator used to provide in situ etching to remove the aluminum oxide on the surface of the substrate was 2 v % of 5 g/L NaF, which was added into the organic solution after copper loading. In some cases, HF was used to replace NaF. Substrates varied from 10 nm to 4000 nm thick sputter deposited Al(Cu) alloy films (Cu concentration from 0 to 2 wt %) on silicon wafers and glass slides and bulk aluminum substrates, to Al, Al—Si, and Al—Cu bond pads on commercial integrated circuits and test vehicles. Semi-continuous Cu seed layers were deposited with and without ultrasonic agitation onto Al surfaces at temperatures between 25° C. and 45° C. with minimal Al substrate dissolution. Copper deposited only on the exposed aluminum and not on any of the non-electrically conducting surfaces. Transmission electron microscopy studies indicated that the majority of Al remained after 80-120 nm thick, semi-continuous Cu layers were deposited from two-phase and single-phase Cu-loaded organic solutions. It was determined that the copper deposited from organic solution was suitable as a seed layer for subsequent build-up of thicker copper films by standard aqueous electroless and electrolytic processes.

### Example F

### Silver Deposition on Copper

Silver was deposited from organic solutions onto a number of different types of copper substrates, including free standing copper foil, sputter deposited copper on a silicon substrate, and patterned copper lines on a printed circuit board. One organic solution composition that was able to be used with all of the copper substrates consisted of 40 v % TBP, 15 v % D2EHPA, and 45 v % kerosene containing 600 ppm Ag. The addition of 9 v % acetic acid and 2 v % fluoroboric acid (50% concentrate form) to the organic solution was done prior to submersion of a copper substrate. Reactions were conducted for times from one to five minutes using ultrasonic agitation of the bath, which was held at 30° C. Results indicated that nano-particles of silver were deposited onto exposed copper surfaces, and that the color of the substrates changed from copper to a shiny, metallic grey after organic solution processing. For the patterned samples, deposition of silver only occurred on the copper surfaces and not on the exposed dielectric of the printed circuit board, indicative of a selective area deposition process.

### Example G

### Gold-Palladium Deposition on Nickel-Vanadium

This example illustrates that alloyed, more noble metal films can be deposited on less noble alloyed metal substrates using an organic solution. First, an organic solution comprised of 20 v % TBP and 80 v % kerosene was loaded with 50 ppm Au and 50 ppm Pd. This solution was then utilized to deposit an alloy containing both Au and Pd on a 0.5 μm thick sputtered 93 wt % Ni-7 wt % V layer on a silicon wafer substrate. The substrate was placed into the Au—Pd loaded solution at a temperature of 30° C. and reacted for two minutes with ultrasonic agitation. Analysis of the sample in an SEM after organic solution processing indicated that there were nano-sized particles containing gold and palladium covering the nickel-vanadium layer. The Au—Pd particles were continuous, forming a film over the entire surface, and had an Au to Pd ratio of 4:1 as determined by EDS.

### Example H

### Alloy Deposition of Silver-Palladium, Tin-Palladium and Copper-Palladium

A mixed alloy containing Ag and Pd was deposited on a copper substrate using an organic solution containing 40 v % TBP and 60 V % kerosene. The Cu specimen was immersed in the organic containing 550 ppm Ag and 275 ppm Pd for one minute at 30° C. with ultrasonic agitation. The resulting deposit was very smooth and bright. The grain size was about three times smaller and the surface was generally more uniform than Ag made without Pd present. The rate of deposition of Ag was also about two times slower, indicating that the Pd may give a denser deposit and restricted access to the Cu surface, which serves as the anode in the spontaneous displacement reaction.

A Cu—Pd deposit was produced on a TiSiN coated silicon wafer substrate after cleaning with de-ionized water and acetone. The organic solution consisted of 30 v % TBP, 20 v % D2EHPA, and 50 v % K with 8 ppm Pd and 110 ppm Cu. In-situ etching was accomplished by adding 2 v % HBF₄. Various additives, including ethanol, acetone, and acetic acid, were used to enhance the deposition process. Of these, the acetic acid at 10 v % gave the best combination of high surface coverage and uniform seed size. The Pd to Cu seed ratio was 2.6:1 by weight.

A deposit containing Pd and tin (Sn) was made on a tungsten (W) substrate after pre-etching in a solution of 1:1:18 of HF:HNO₃:H₂O for three minutes. The organic solution of 40 v % TBP, 13 v % D2EHPA, and 47 v % K contained 30 ppm Pd and 2000 ppm Sn. Seeding was conducted using ultrasonic agitation for five minutes at a temperature of 30° C. The measured Pd/Sn seed ratio was approximately 8:1 by weight.

The present invention allows for displacement deposition onto surfaces that are difficult or impossible to plate using conventional aqueous solutions. Components deposited using the process of the present invention have better adherence than prior art methods. In addition, a variety of different organic-metal or ion systems can be used with the present invention.

The invention is particularly useful for deposition of engineered or thin films for high technology coatings. For example, wafers or chips used in the electronics industry can be coated. Improved contacts for metals used in electrical applications are provided by the present invention. There are numerous applications for the present invention in the MEMS industry. Other industries, such as the automotive industry, may utilize the present invention for engine or other components.

The preceding examples can be repeated with similar success by substituting the generically or specifically described reactants and/or operating conditions of this invention for those used in the preceding examples.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

1. A deposition method comprising the steps of:
providing a substrate comprising an active substrate at least one material selected from the group consisting of a metal, metal alloy, and metal containing compound;
contacting the substrate with a non-aqueous non-conducting organic solution comprising a desired deposition galvanic coating component, the desired deposition galvanic coating component having a more noble composition than the less noble composition of the active substrate; and
depositing seeds in a localized range on the active substrate, wherein the seeds comprise particles of the desired deposition galvanic coating component;
spontaneously displacing the active substrate with the desired deposition galvanic coating component in a localized range on the active substrate adjacent to the seed sites;
continuing depositing in a localized range the desired deposition galvanic coating component from the non-aqueous non-conducting organic solution onto the active substrate; and
growing the deposit from the seed sites.

2. (canceled)

3. The method of claim 1 wherein the desired deposition component comprises a seed composition comprising a material selected from the group consisting of copper, platinum, palladium, gold, zinc, iron, cadmium, silver, lead, cobalt, nickel, and mixtures thereof.

4. The method of claim 1 wherein the desired deposition component comprises a metal.

5. The method of claim 4 wherein the desired deposition component comprises a material selected from the group consisting of copper, gold, platinum, palladium, silver, lead, zinc, tin, nickel, iron, and mixtures thereof.

6. (canceled)

7. (canceled)

8. (canceled)

9. The method of claim 1 wherein the substrate comprises at least one material selected from the group consisting of tungsten-based, tantalum-based, and titanium-based materials.

10. The method of claim 9 wherein the substrate comprises at least one material selected from the group consisting of Ti, Ta, W, TiN, TaN, W₂N, TiSiN, WN, WSiN and TaSiN.

11. (canceled)

12. (canceled)

13. The method of claim 1 wherein the organic solution comprises at least two deposition components.

14. The method of claim 1 wherein the substrate comprises a barrier layer.

15. The method of claim 1 further comprising the step of treating the substrate.

16. The method of claim 15 wherein the treating step comprises introducing a halogenated compound into the organic solution.

17. The method of claim 16 wherein the halogenated compound comprises at least one material selected from the group consisting of HBF₄, HF, NaF, H₂SiF₆, and HCl.

18. The method of claim 15 wherein the treating step comprises introducing a non-halogenated compound into the organic solution.

19. The method of claim 18 wherein the non-halogenated compound comprises H₂SO₄.

20. (canceled)

21. (canceled)

22. (canceled)

23. (canceled)

24. (canceled)

25. (canceled)

26. (canceled)

27. The method of claim 1 wherein the organic solution comprises a cation exchange reactant.

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. The method of claim 1 further comprising the step of using temperatures from ambient to elevated levels.

45. (canceled)

46. (canceled)

47. (canceled)

48. The method of claim 1 wherein the organic solution comprises less than 5% water by volume.

49. The method of claim 1 wherein the organic solution comprises less than 0.25% water by volume.

50. The method of claim 1 further comprising removing a surface coating of a barrier layer.

51. The deposition method of claim 1 wherein the depositing of the desired deposition component comprises displacing components from a layer of the active substrate with the desired deposition component.

52. (canceled)

53. The method of claim 14 wherein the surface coating of the barrier layer comprises at least one material selected from the group consisting of an oxide and a nitride.

54. (canceled)

55. The method of claim 1 wherein galvanic coating comprises separate galvanic coating comprising:
loading the organic solution with the deposition component; and
reactively reducing in the organic solution.

56. (canceled)

57. (canceled)

58. The method of claim 1 wherein the desired deposition component comprises a metal ion.

59. (canceled)

60. The method of claim 1 wherein the desired deposition galvanic coating component comprises at least one material selected from the group consisting of an ion, and a neutral molecule.

61. The method of claim 1 wherein the composition of the seed particle comprises at least one non-metallic element.

62. The method of claim 15 wherein the treating step comprises introducing at least one material selected from the group consisting of an acid and a base into the organic solution.

63. The method of claim 15 wherein the step of treating the deposition substrate comprises etching the substrate.

64. The method of claim 63 wherein the step of etching the substrate comprises pre-etching the substrate prior to the deposition step.

65. The method of claim 63 wherein the step of etching the substrate comprises in-situ etching of the substrate during the deposition step.

66. The method of claim 1 wherein the organic solution is a single phase solution.

67. The method of claim 1 further comprising the step of mixing or agitating the organic solution.

68. The method of claim 67 wherein the mixing comprises ultrasonic agitation.

69. The method of claim 1 further comprising the step of adding at least one additive in the organic solution.

70. The method of claim 69 wherein the additive comprises at least one member selected from the group consisting of organics, inorganics, acids, bases, salts, and mixtures thereof.

71. (canceled)

72. The method of claim 70 wherein the inorganic additive comprises at least one component selected from the group consisting of water, acids, bases, activating cations, activating anions, and mixtures thereof.

73. The method of claim 1 further comprising the step of transporting reacting species.

74. The method of claim 1 further comprising the step of elevating the pressure.
